(19) United States
(12) Patent Application Publication
(10) Pub. No.: US 2022/0279742 A1
(43) Pub. Date: Sep. 8, 2022

(54) Growing System and Apparatus

(71) Applicant: Inventive Laboratory Inc., St-Eustache (CA)

(72) Inventor: François TREMBLAY, St-Eustache (CA)

(21) Appl. No.: 17/722,961

(22) Filed: Apr. 18, 2022

Related U.S. Application Data
(63) Continuation of application No. PCT/CA2020/051393, filed on Oct. 16, 2020.
(60) Provisional application No. 62/916,039, filed on Oct. 16, 2019.

(51) Int. Cl. A01G 31/04; A01G 7/04

(52) U.S. Cl. CPC A01G 31/042; A01G 7/045; A01G 2031/006

(57) ABSTRACT

A growing system is described. The growing system includes a conveyor system, at least one floating tray, a plurality of multifunction beams arranged to contain at least one row, a microclimate exchange system, and a nutriment supply system.

### CROSS-REFERENCE TO RELATED APPLICATIONS

The present application is a continuation of International PCT Application No. PCT/CA2020/051393 filed on Oct. 16, 2020, which claims priority from U.S. Provisional Application No. 62/916,039 filed on Oct. 16, 2019, both incorporated by reference herein in their entireties.

### TECHNICAL FIELD

The following relates to a growing system and apparatus, in particular for hydroponic growing systems.

### BACKGROUND

Vertical farming has become an increasingly efficient, effective and popular way to grow crops that have a relatively limited height. In such systems, racks containing rows of growing beds are stacked upon each other within a growing room or facility.

However, by stacking plants in rows and multiple modules, with multiple rows and/or modules being typically located in the same growing room, the requirements for air flow, irrigation, lighting, services, cleaning, nutriment distribution, and atmospheric conditions can become challenging. Deploying and harvesting plants within such confined spaces can also be difficult.

It is an object of the following to provide a growing system and apparatus that addresses at least one of the above challenges.

### SUMMARY

In one aspect, there is provided a conveyor system for a growing system, comprising: a conveyor belt extending from one end of a row in the growing system to the other end of the row; a first drive assembly coupled to the conveyor belt at the one end of the row; a second drive assembly coupled to the conveyor belt at the other end of the row; and a drive mechanism for operating the first and second drive assemblies and conveyor belt; wherein the conveyor belt is attachable to objects to be conveyed along the row.

In another aspect, there is provided a floating plant tray, comprising: a buoyant body, the buoyant body comprising a plurality of insertion points for accepting a plant substrate.

In yet another aspect, there is provided a multifunction beam for a growing system, the multifunction beam for installation along rows of the growing system, the beam comprising: a profiled shape comprising a plurality of enclosed chambers and a plurality of slots or channels to interact with the growing system.

In yet another aspect, there is provided a microclimate exchanger device, comprising: a body comprising an air flow guide to guide air from an inlet through a cool coil assembly, through a hot coil assembly, and to an outlet; at least one fan at the inlet of the body; an air direction controller at the outlet of the body; and an air filter positioned between the inlet and the outlet.

In yet another aspect, there is provided a microclimate exchange system, comprising: at least one exchanger device as defined above; a chiller; a boiler; a plurality of fans positioned within an area of a growing system to direct air through the at least one exchanger device; and a plurality of enclosure panels to isolate the area.

In yet another aspect, there is provided a nutriment distribution system, comprising: a tank structure comprising at least one tank; a nutriment station coupled to the at least one tank; a pump unit coupled to the at least one tank and coupled to a growing system in a plant space; and a software module configured to control distribution of the nutriment from the nutriment station to the plant space via the tank structure.

In yet another aspect, there is provided a growing system comprising: a conveyor system as defined above; at least one floating tray as defined above; a plurality of multifunction beams arranged to contain at least one row, as defined above; a microclimate exchange system as defined above; and a nutriment supply system as defined above.

### BRIEF DESCRIPTION OF THE DRAWINGS

Embodiments will now be described with reference to the appended drawings wherein:

FIG. 1 is a pictorial view of a vertical farming environment.

FIG. 2 is a perspective view of a conveyor assembly.

FIG. 3 is a perspective view of a driving assembly in isolation.

FIG. 4 is a perspective view of a driven assembly in isolation.

FIG. 5 is a perspective view of an idle assembly in isolation.

FIG. 6(a) is a perspective view of a floating tray assembly.

FIG. 6(b) is a perspective view of a cleaning device.

FIG. 7 is a perspective view of a multifunction beam having a gas chamber and flow control orifice.

FIG. 8 is a partial perspective view of the multifunction beam showing an orifice distribution along the beam.

FIG. 9 is an elevation view of the multifunction beam showing a flow control orifice from the gas chamber.

FIG. 10 is an enlarged cross-section of a portion of a multifunction beam illustrating a vented screw in communication with the gas chamber.

FIG. 11 is a perspective view of a microclimate exchanger device.

FIG. 12 is a schematic diagram of a microclimate exchanger and hydraulic system.

FIG. 13 is a schematic end view of a microclimate exchange through the microclimate exchanger device.

FIG. 14 is a schematic diagram showing air flow within an enclosed row using side plates and fans.

FIG. 15 is a partial perspective view of a multifunction beam showing assembly channels for connected multiple beams together end-to-end.

FIG. 16 is an end view of a multifunction beam showing a light mounting profile.

FIG. 17 is a partial perspective view of a mounting assembly bracket and seal applied to adjacent multifunction beams.

FIG. 18 is a partial perspective view of an end of a multifunction beam having assembly guides.

FIG. 19 is a perspective view of a multifunction beam and irrigation drain connected thereto.

FIG. 20 is a partial perspective view of a multifunction beam supporting a lighting device coupled thereto.

FIG. 21 is a partial perspective view of a row with an end plate attached to the multifunction beams.

FIG. 22 is a partial perspective view of a multifunction view illustrating the distribution of gas distribution orifices.

FIG. 23 is a schematic diagram showing a dual tank per nutriment configuration for nutriment distribution.

FIG. 24 is a schematic diagram showing a single tank per nutriment configuration for nutriment distribution.

FIG. 25 is a perspective view of a floating tray assembly.

FIG. 26 is an enlarged partial perspective view of a portion of the floating tray assembly.

FIG. 27 is a perspective view of a top view of the floating tray.

FIG. 28 is a perspective view of a bottom view of the floating tray.

FIG. 29 is a cross-sectional view of a substrate container cage illustrating a configuration permitting air flow therearound.

### DETAILED DESCRIPTION

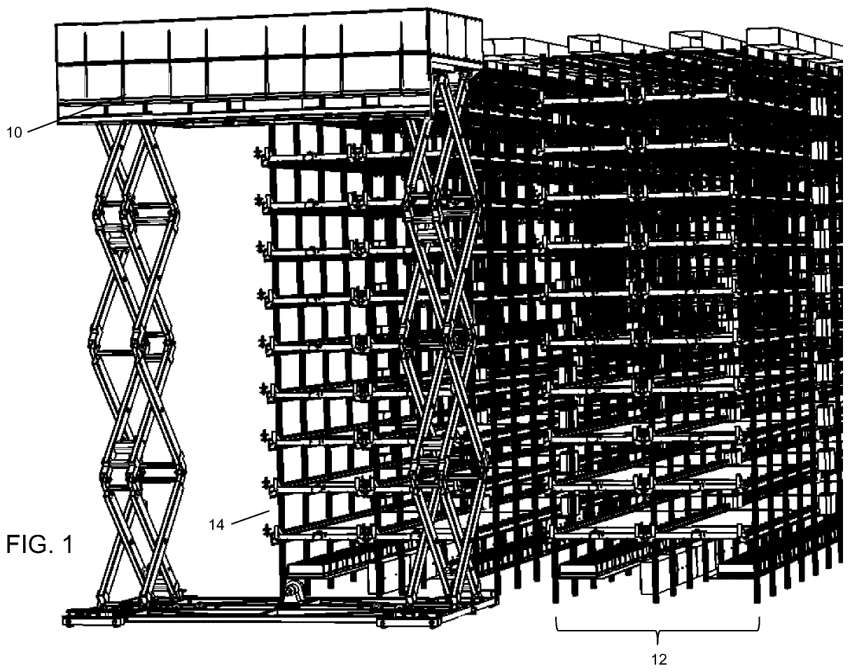

Turning now to the figures, FIG. 1 illustrates an example of a crop growing system having a number of modules 12 positioned in a growing room. Each module 12 includes a number of rows 14, with each row 14 being configured as a bed or elongated substrate for containing a growing medium such as soil or a liquid (e.g., containing water). In the examples shown herein a hydroponic growing system is described wherein the rows 14 contain a liquid as the growing medium, however, it can be appreciated that the principles described herein may equally apply to similar crop growing systems that utilize soil as the growing medium. Also shown in FIG. 1 is a harvesting platform 10 that can be lifted and positioned at a particular row 14 to permit loading of a row 14 with plant trays (described below), and to permit retrieving of such plant trays during a harvesting operation.

### Buoyancy Conveyor

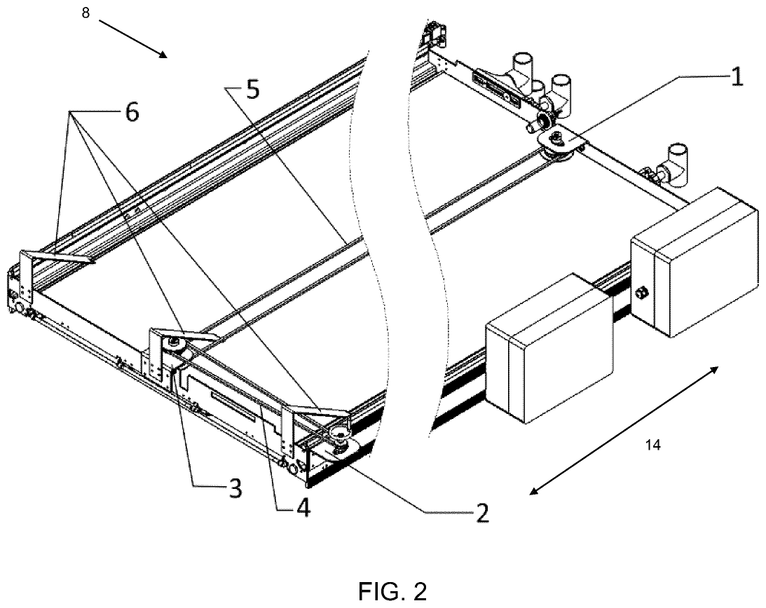

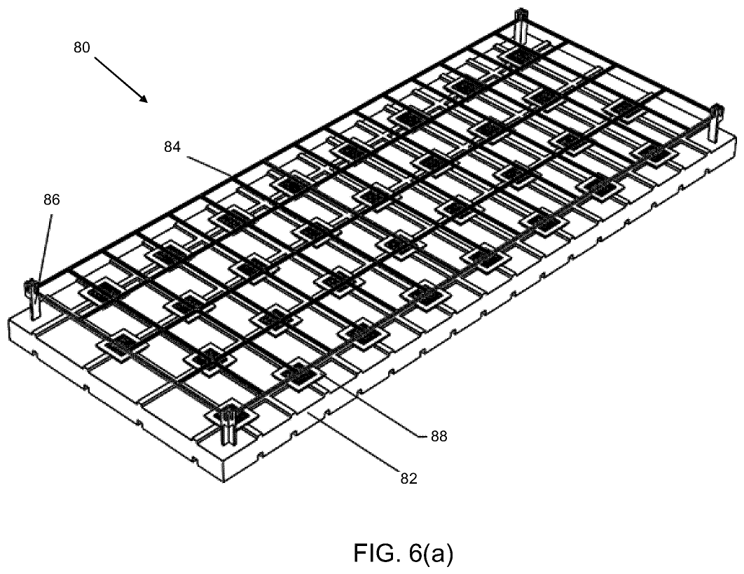

FIG. 2 shows an overall assembly 8 for a buoyancy conveyor of the assembly 8, broken along its length for ease of illustration. It will be appreciated that the assembly 8 would be installed along the length of a row 14 and certain components shown in FIG. 2 that cross the break would extend from one end of the row 14 to the other. Shown in FIG. 2 are an idle assembly 1 to permit a user to convey a floating tray along the row 14 as described in greater detail below, a driving assembly 2 for operating a driving belt 4, a driven assembly 3 being operated by the driving belt 4 to in turn operate a conveyor belt 5. The assembly 8 also includes a plurality of access ramps 6 to facilitate the loading and unloading of floating plant trays (see FIG. 6(a)) and/or a cleaning system (see FIG. 6(b)).

The assembly can therefore also use a cleaning device made of several nozzles to uniformly distribute water pressure along the row 14. The assembly 8 uses a plant carrying tray to maintain and position the plants in the row. To move the plant carrying tray and the cleaning device in the row 14, the conveying system shown in FIG. 2 is used, which can be made of a plastic belt and a handle used to “push” or “pull”. The rotating conveyor mechanism is installed on both ends of the row 14. It can be appreciated that the far end of the row 14 can rely on a simplified version of the rotating conveyor mechanism since it does not need to interface with the rotating handle. As suggested by the break lines in FIG. 2, the row 14 can be of any length.

To avoid friction between the plant carrying tray and a bottom membrane of the row 14, the plant carrying tray is configured to be a floating device allowing the tray to float when the row 14 is filled with liquid. The conveyor belt 5 interacts with the floating tray to provide an attachment point between the tray and the assembly 8 such that operating the drive mechanism conveys the plant tray along the row 14 either away or towards the user. The bottom membrane (not shown) is layered on top of a panel that spans the width of the row 14 and is supported by the multifunction beams described herein. For example, ridges or other profiles can be incorporated to enable the panels to be slid into the row 14 to support the membrane. It can be appreciated that the panels can be supported from beneath and urged upwardly along the mid portion thereof to cause the panels to flex and encourage drainage away from the mid portion.

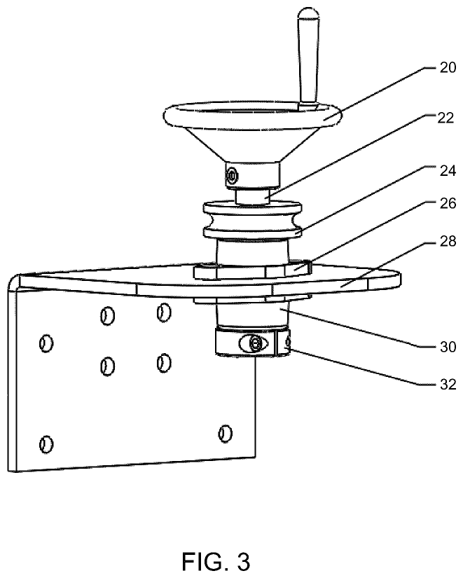

FIG. 3 shows further detail of the driving assembly 2. The driving assembly 2 includes a handle 20, a rotating shaft 22 to be rotated by the handle 20, a handle driving belt pulley 24 that is rotated with the shaft 22, an upper flanged bearing 26, a holding bracket 28 to secure the driving assembly 2 to the row 14, a lower flanged bearing 30, and a shaft lock 32 to maintain a selected position (i.e. to inhibit further movement of the conveyor belt 5).

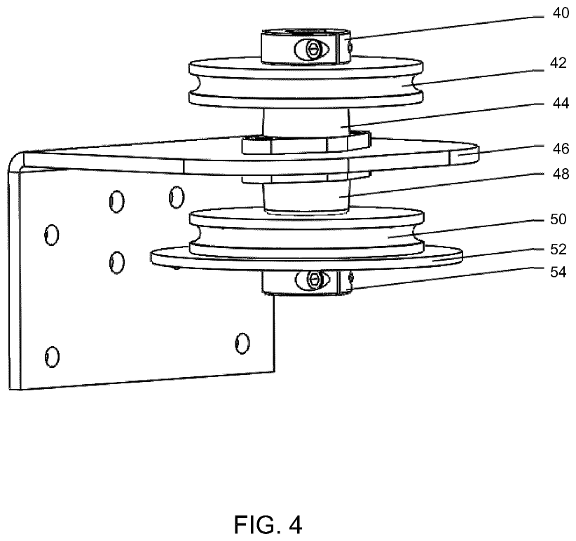

FIG. 4 shows further detail of the driven assembly 3. The driven assembly 3 includes an upper shaft lock 40, a driving belt pulley 42, a flanged bearing 44, a holding bracket 46 to enable the assembly 3 to be secured at one end of the row 14, a conveyor belt pulley 50, a belt guide disc 52, and a lower shaft lock 54. It can be appreciated that the assembly 3 includes a rotating shaft not seen in FIG. 4, which would run through the assembly 3 and is held by the two shaft locks 40, 54. The driving belt pully 42 and the conveyor belt pully 50 rotate with the rotating shaft.

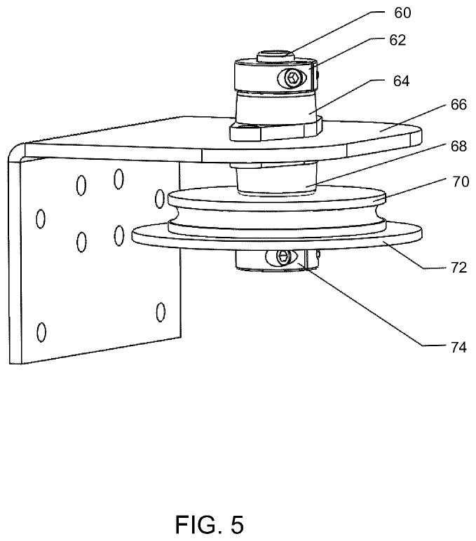

FIG. 5 shows further detail of the idle assembly 1. The idle assembly 1 includes a rotating shaft 60, an upper shaft lock 62, an upper flanged bearing 64, a holding bracket 66 to permit the assembly 1 to be secured at the other end of the row 14, a lower flanged bearing 68, a conveyor belt pulley 70, a belt guide disc 72, and a lower shaft lock 74.

FIG. 6(a) shows an example of a floating tray assembly 80. The floating tray assembly 80 includes a floating tray 82, a heavy crop support netting 84, a net support 86, and a number of substrate container cages 88.

To load a plant tray assembly 80 into a row 14, the user fills the row 14 with liquid, and assembles the plant tray 82 to include the plant substrate, plant pot and the actual plant. The user may then slide the plant tray 82 (which may also include elements 84, 86, 88 shown in FIG. 6(a)) into the rows using the access ramps 6. The user can then secure a first plant tray 82 to the conveyor belt 5 using an attachment apparatus. Since the row 14 is filled with a liquid and the plant tray 82 is buoyant, the plant tray 82 will float along the row 14 and can be conveyed by operating the belt 5. The user may then assemble any additional (subsequent) plant trays 82 to include the plant substrate, plant pot and the actual plant. With each subsequent plant tray 82, the user slides the plant tray 82 into the row 14 using the access ramps 6 while pushing the previous tray 82. This can be repeated for each additional plant tray 82 that is meant to be positioned in that row 14. It can be appreciated that once placed, the row 14 can be emptied and/or refills to apply a watering cycle or nutriment cycle as explained later.

To unload the plant trays 82, the user fills the row 14 with liquid (if not already filled), to have the plant trays 82 float yet again. The user then rotates the handle 20 in such a way that the plant tray 82 is pulled back towards the user to become accessible and may be slid out of the row 14 using the access ramps 6. The user may then disassemble the plant tray 82 to retrieve the plants. The user may then repeat these operations for any additional plant tray 82 in the row 14. The last plant tray 82 is then detached from the conveyor belt 5 and the row 14 can be emptied of the liquid if required.

FIG. 6(b) illustrates an example of a cleaning device 90 having a cover 92 and a spray tubing 94 to enable water to be fed and sprayed over the row 14 while being contained by the cover 92. To convey the cleaning device 90, the user may load the cleaning device 90 into the row 14 and attach it to the conveyor belt 5. The cleaning device 90 can be started by feeding water through the tubing 94. The user may then rotate the handle 20 in such a way to move the cleaning device 90 back and forth along the row 14 in the same way as conveying the plant trays 82 for loading and unloading. In this way, the conveyor assembly 8 provides dual functionality and can be used to convey any other mechanism that needs to traverse a row 14.

When finished the cleaning cycle, the cleaning device 90 can be detached from the conveyor belt 5 and unloaded via the ramps 6.

### Uniform CO₂, Humidity and Other Gas Injection

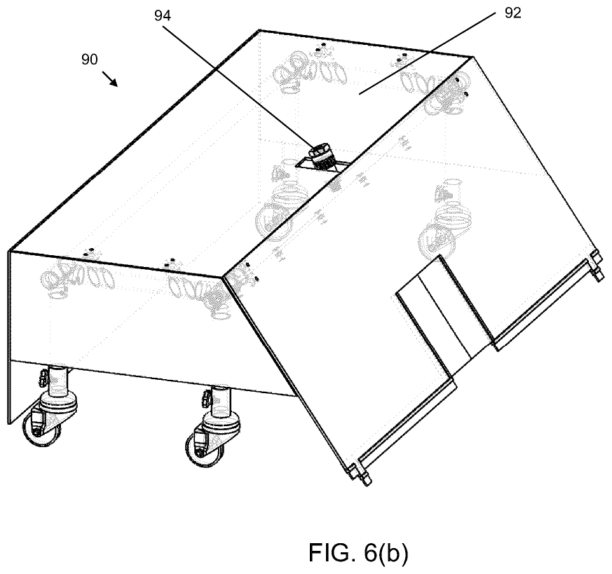

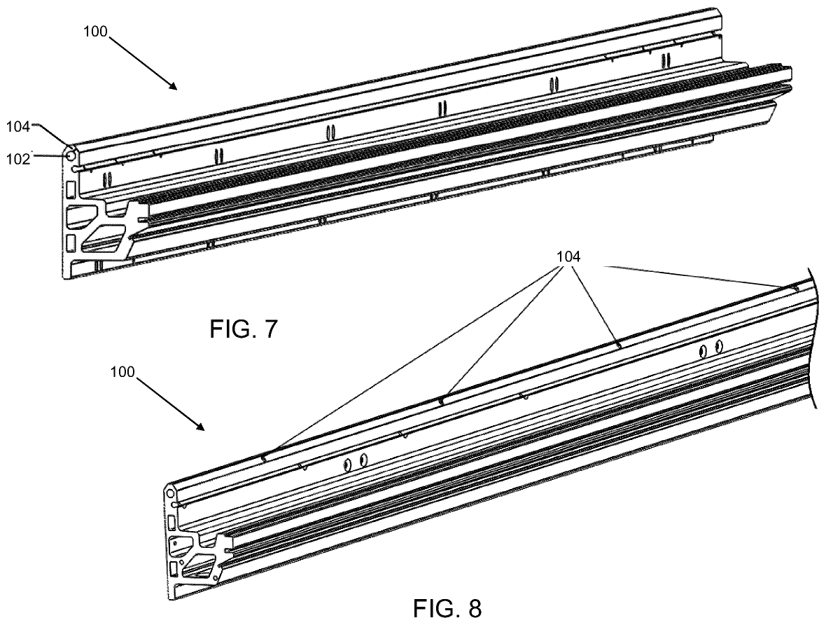

As seen in the assembly 8 shown in FIG. 2, specially designed beams are installed along the sides of the row 14 and are leveraged to integrate a number of particular features. One such feature is the conveyance and distribution of gases along the length of the row 14. An example of a beam 100 is shown in FIGS. 7 and 8. For example, CO₂, humidity and other gas injection can performed in such a way to achieve a uniform distribution along the rows 14. For the sake of brevity, the term “gas” will be used to refer to any medium that can be conveyed and distributed via the beams 100. That is, CO₂ and humidity (humid air or steam) injection may be generally considered a specific application of “gas injection” as herein described.

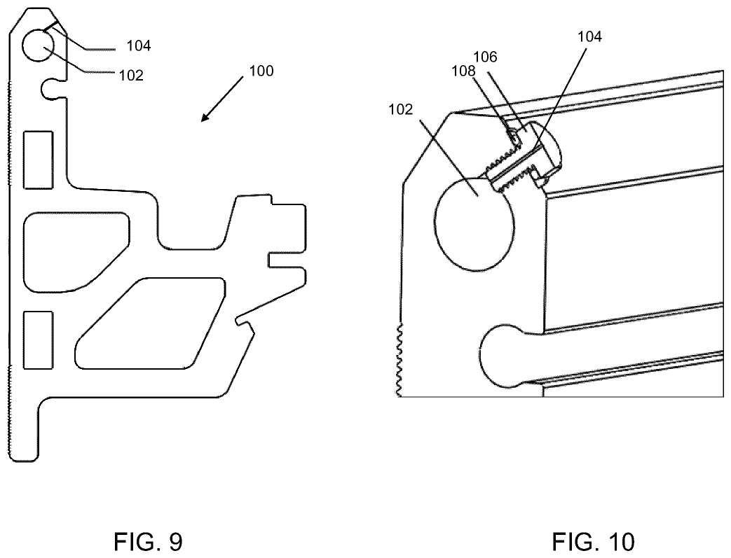

The uniform distribution of gas is achieved using a pressurized gas chamber 102 integrated within the structure of the beam 100 and using precision orifice flow control distributed along the beam 100. As best seen in FIG. 9, the gas injection is preferably performed at an inclined plane to optimize the distribution towards the plants. The gas injection can be performed using an orifice 104 directly machined into the beam or using inserts such as screw or press fitted insert with or without pre machined orifice. FIG. 8 illustrates a uniform distribution of orifices 104 along the length of the beam 100.

Turning now to FIG. 10, custom made venting screws 106 can be used to modulate the flow control depending on the requirements of the system, to add modularity to the system, and to ease maintenance. The screw 106 thus can be adapted to include the orifice 104 shown in FIG. 9 in a replaceable manner to permit different orifices 104 and screw materials. The material chosen for the screws 106 can be selected according to the gas being used (e.g., to achieve chemical compatibility). The diameter of the orifice 104 is chosen according to the desired gauge pressure (i.e. the pressure difference between the environment pressure and the gas chamber pressure), the desired flow rate to the row 14 (gas flow rate towards the plants) and the input flow rate (the gas flow from the source of gas—e.g., a gas tank).

When using a vented screw 106, the screw 106 is sealed to the beam 100 using an O-ring 108 to ensure no leakage. In this way, the flow rate is controlled from only the orifice 104. Since the screw 106 is easily replaceable, flow control can be achieved by having different sized orifices 104 in swappable screws 106. A proper receiving surface on the beam side can also be added to ensure good sealing. It can be appreciated that FIG. 9 illustrates the orifice 104 more generally such that it can be machined directly into the beam 100 but may also be adjustable by way of the screw 106 as shown in FIG. 10. That is, the orifice 104 can be incorporated into the beam 100 in multiple ways.

### Microclimate Control System

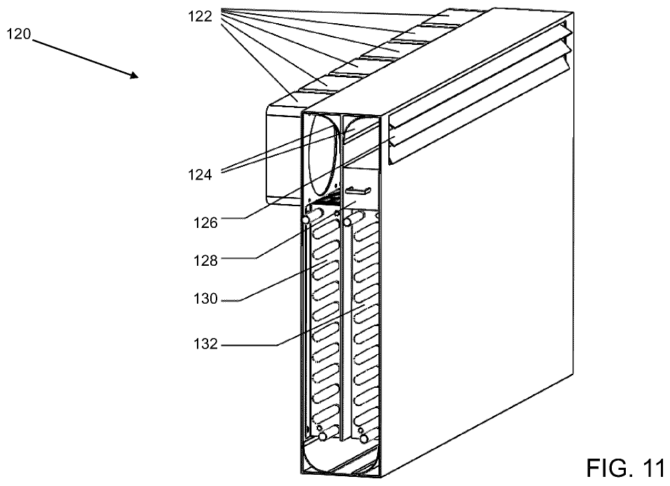

In vertical farming, the capacity to create an ideal environment is typically considered to be very important. Most vertical farms have the same climate everywhere within the growing room, which can limit significantly the variety and performance of the plant production operation. The system described herein can also include a microclimate control system to allow for the control of small individual climate units (Microclimates) for each batch of plant. In an environment such as that illustrated in FIG. 1, such a system allows for the control of a different climate for every level of a module 12. An example of a microclimate control system is shown in FIGS. 11 to 14.

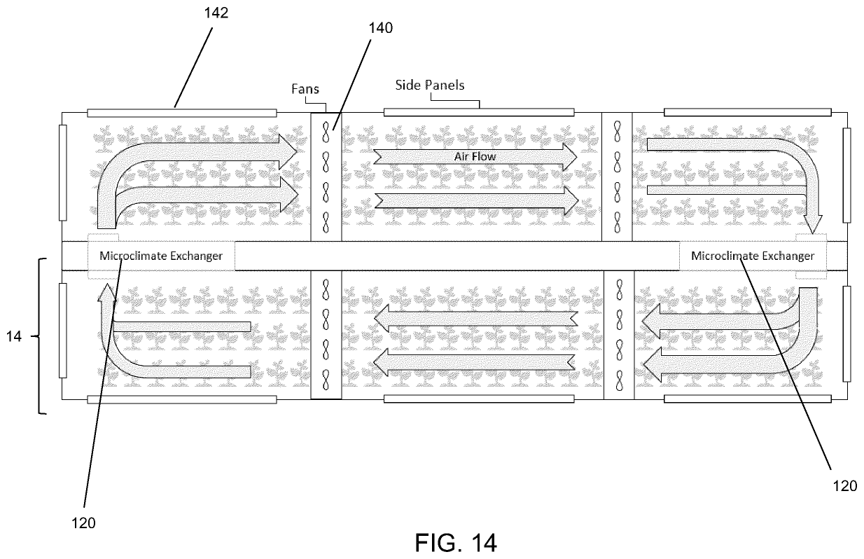

An objective of the microclimate system is to isolate the level in the module 12 completely. It can be appreciated that each “level” may contain one or more rows 14. For example, the module 12 shown in FIG. 1 includes a pair of rows 14 side-by-side at each level. Circulating air in opposite directions on both ends of the level as shown in FIG. 14 can be achieved using fans for environment uniformity. The exchange of air from one side of the level to the other on both ends is achieved by having the air pass through a microclimate exchanger device 120 shown in FIG. 11. The device 120 processes the air in such a way to achieve the targeted temperature and humidity. Doing this also allows the control of an individual gas (such as CO₂) concentration for that level. FIG. 11 illustrates the microclimate exchanger device 120 with the front panel removed. The device 120 includes a series of fans 122 to direct the air into an air flow guide 124 to exit at an exit air direction controller 126. The device 120 also includes a filter 128, a cool coil assembly 130, and a hot coil assembly 132.

The device 120 and configuration shown in FIG. 14 allows for the removal of air handler type equipment. This simplifies the complete climate control system to a chiller, heat pump (facultative) and boiler (or electric heater).

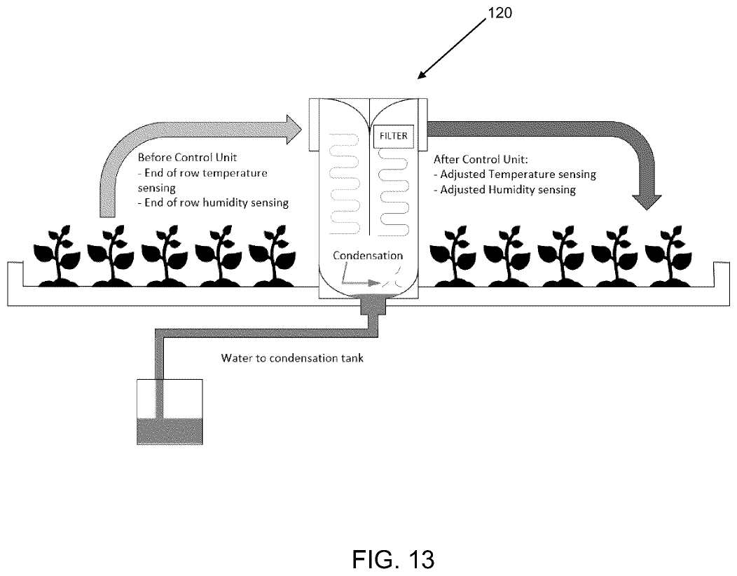

To achieve a control loop, temperature and humidity sensors are located in the targeted control space. The condensation water generated can be recycled to a condensation tank. To achieve adequate regulation, a microclimate device 120 can be located at one end or both ends of the level if necessary as seen in FIG. 13.

Referring also to FIG. 14, the exchanger system therefore integrates a number of fans 140 positioned in each row 14, with one or more exchanger devices 120 and enclosure panels 142 installed around the level to enclose the level (i.e., to enclose a pair of rows 14). Temperature and humidity sensors are also integrated into the system to monitor and control the temperature and humidity. It can be appreciated that the cool coil 130 can be controlled by a cool variable valve and the hot coil 132 can be controlled by a hot variable valve. As indicated above, condensed water can drain out of the exchanger device 120 and be collected by connecting a basin or other vessel to the device 120. The exchange 120 may also include an air thigh enclosure. Optionally, a heat pump can be added in the hydraulic loop to increase the system efficiency. As such, to provide a cooling operation, the system increases the opening of the cool variable valve and to provide a heating operation, the system increases the opening of the hot variable valve. To control dehumidification, the system can increase the opening of both the cool and hat variable valves.

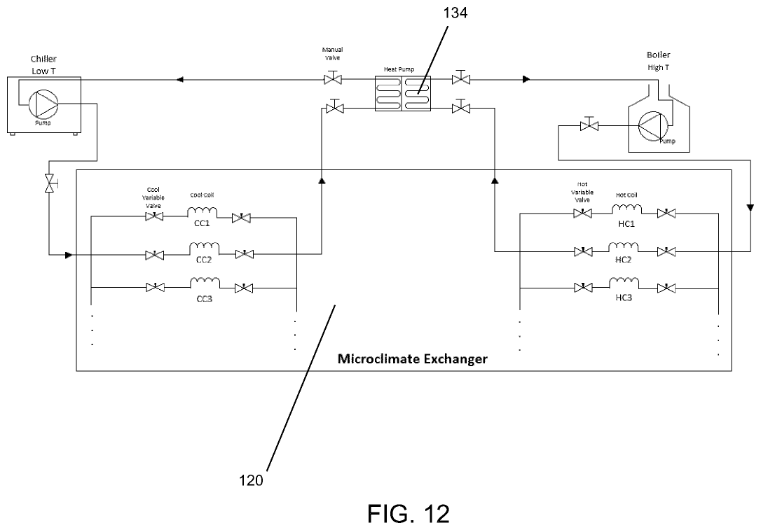

FIG. 12 shows a hydraulic schematic of the microclimate exchanger device 120 and the complementary systems, which include the cool Coil, the cool variable valves, the hot coils, the hot variable valves and a heat pump 134.

FIG. 14 illustrates an end of row schematic of the microclimate exchanger unit and its surrounding environment. Here, it can be seen that the condensing water drains from a connector to a condensation tank. The filtering mechanism is also illustrated. Temperature and humidity sensors are used before and after unit 120 for control purposes.

It can be appreciated that the system shown in FIGS. 11-14 addresses problems normally experienced in vertical farming where a single duct at each end provides the same temperature and humidity to all the growing environment(s). The system described herein can enable levels to be enclosed and individually controlled thus greatly increasing the flexibility of the growing system.

### Smart Beam Support

It is recognized that vertical farms require several systems to fulfill the needs of the targeted crop. For example, the crop may require specific temperature, humidity, CO₂, irrigation, fertilizer, lighting, etc. Further detail of the structural beam 100 will now be provided to illustrate how the beam 100 can be configured to allow for the distribution of several of these systems.

The beam 100 is configured to facilitate irrigation through the uniform distribution of the irrigation water through multiple drains that are installed along its distribution channel and the installation of a membrane to receive the irrigation solution. To provide gas, as discussed above, gas (such as CO₂) is injected through injector place along its channel. For wiring, a service channel is accessible for the passing of various electrical cable, for lighting a mounting profile is provided to guide at a precise angle the lighting device to ensure uniform distribution of light, and for assembly several assembly profiles are present to allow easy and quick mounting.

The beam 100 is also modular in that it can be extended to any length while keeping all mentioned capabilities. Maintenance and cleaning operations are accessible through various access ports. The beam 100 provides structural integrity through a design to safely support the vertical farm structure and provides an enclosed space, generally a full row, where the environment is controlled for optimal growth of the plants.

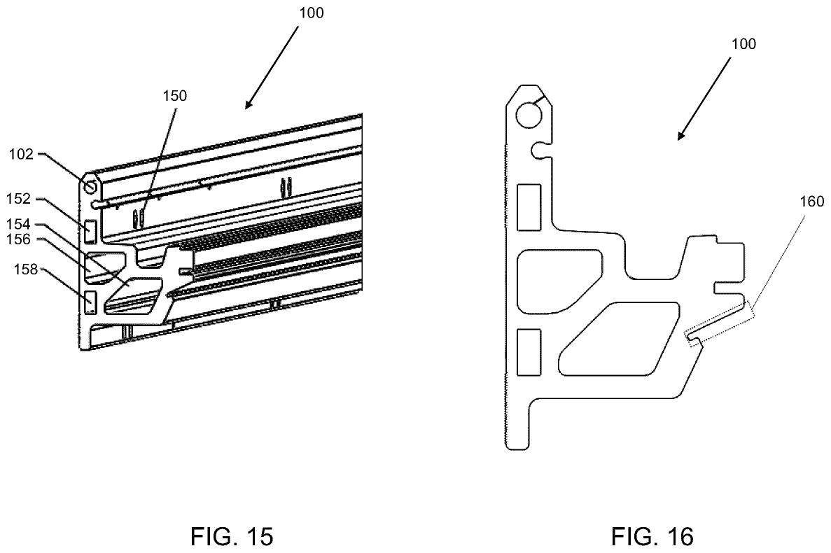

FIG. 15 shows a cross section of the multifunction beam 100. The beam 100 includes the aforementioned gas channel 102, an upper assembly channel 152, an irrigation channel 154, a service channel 156, a lower assembly channel 158, and mounting holes 150. In addition to the beam 100, the support system may include a seal, module assembly bracket, assembly guide, irrigation drain, irrigation connector, lighting bracket, lighting device, end bracket, maintenance access port, and gas injector.

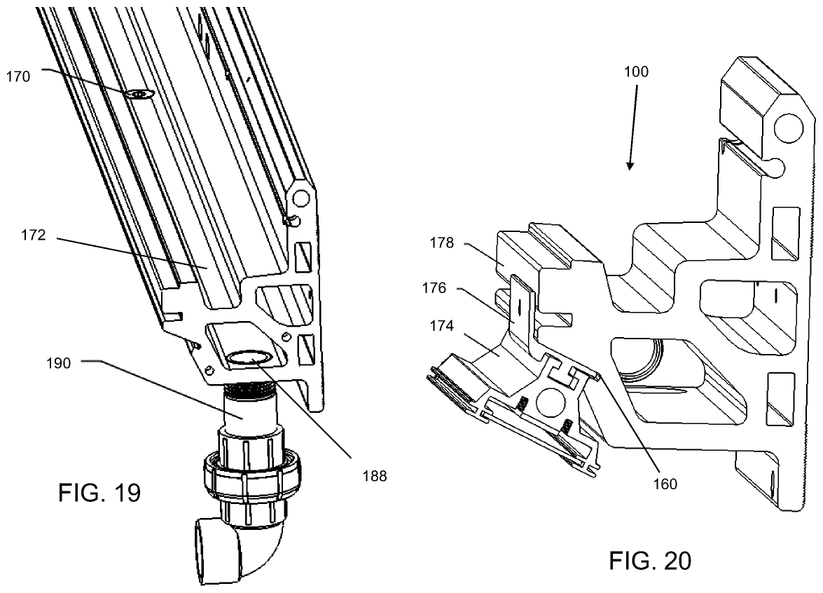

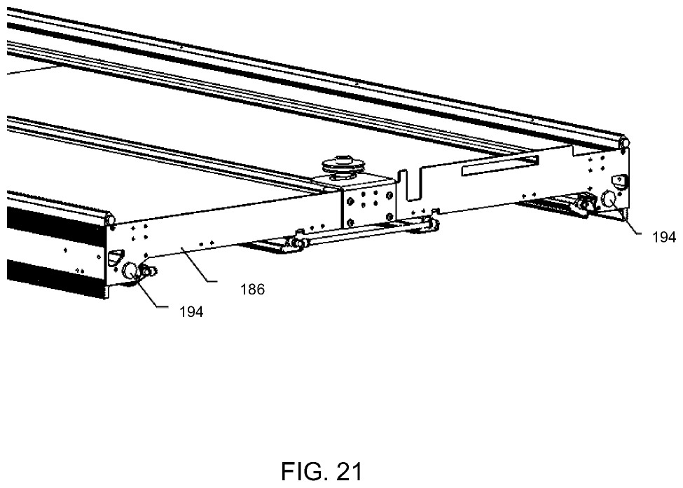

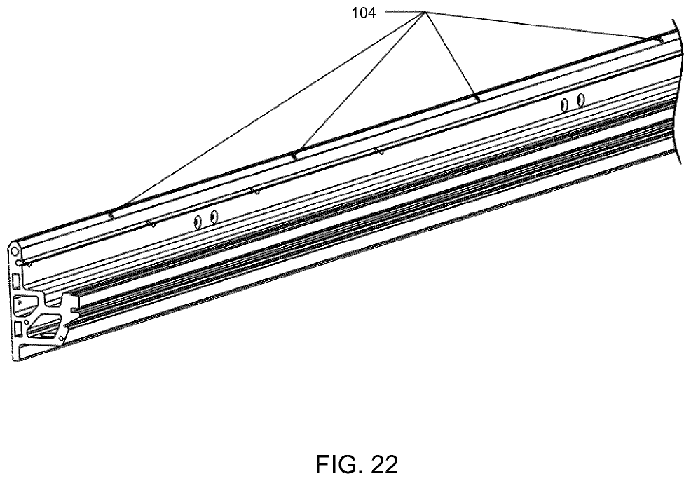

For providing irrigation, the beam 100 may be used as follows. An irrigation solution (including fertilizer or not) can sent through the irrigation connector such that the irrigation channel 154 is filled with the solution. The solution then uniformly enters the plant space through drain holes 170 in an upper channel 172 of the beam 100 as illustrated in FIG. 19. An end plate 186 (shown in FIG. 21) and the membrane within the row 14 maintain the irrigation solution in the plant space. The drain holes 170 are also used in a reverse operation for draining the plant space.

For distributing gas, the gas channel 102 is pressurized at an operational pressure level and the gas is distributed through the gas injector orifices 104 at an equal flow as shown again for convenience in FIG. 22.

For distributing wiring, the system can use the service channel 156 for passing of various electrical cables. An opening along the channel can be provided to give side access.

For lighting, as shown in FIGS. 16 and 20, a lighting device 174 can be assembled with a lighting bracket 176 to slide within a lighting profile 160 (see FIG. 16). The bracket 176 rests against an edge 178 of the beam. That is, the lighting device 174 is mounted to the multifunction beam 100 using the light mounting profile 160 such that the lighting device 174 can be easily removed for maintenance.

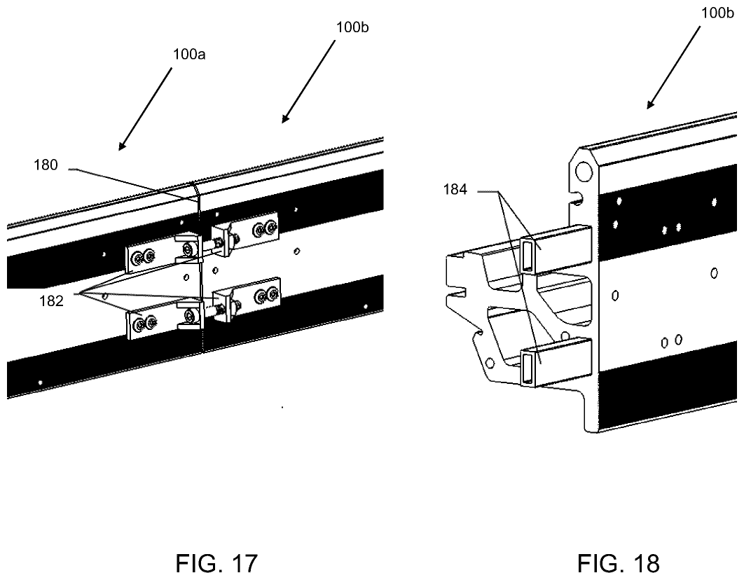

The beams 100 can also be made modular such that they can be assembled end to end to each other as shown in FIGS. 17 and 18. First, as seen in FIG. 17, a pair of beams 100a, 100b can be joined to each other using a seal 180 and a pair of mounting brackets 182.

Turning next to FIG. 18, a pair of guides 184 extending from one end of beam 100b can be inserted into channels or pockets (see numerals 152 and 156 in FIG. 15) of beam 100a prior to installing the seal 180 and mounting brackets 182. It can be appreciated that several beams 100 can be installed in series together as shown along the length of a row 14 as needed.

As shown in FIG. 19, an irrigation drain 188 can be included on the bottom surface of the irrigation channel 154 and connected to an irrigation connector 190 to permit the drained water to be collected and recycled. Also, as shown in FIG. 21 are a pair of maintenance ports 194 to permit access to the channels 154 via the end plate 186.

### Nutriment Solution Recycling

It is found that in a vertical farm using hydroponics, the use of a system to add nutriments to the water is important. A device and system have been configured to allow for recycling of a nutriment solution through a liquid storage system. A system of tanks can be used to store the liquid until it is needed for irrigation. A software module is then used to manage and control the solution characteristics and the specifics of its use and application. The system described herein can allow for simultaneous availability of multiple nutriment solutions at any time and can optimize the usage of water and minimize waste.

Nutriment solutions are adjusted in pH and the concentration can be controlled with 2 different technics:

1. The control and monitoring of individual Nitrogen (N), phosphorus (P) and potassium (K) concentrations.

2. The control and monitoring of electrical conductivity and the type of nutriment (Early Grow, Grow, Flower, etc. . . . ).

There is the possibility of operating the system using 2 tanks per solution (i.e. with a return tank and a supply tank), and 1 tank per solution. Considering the same tank space, the dual tanks per solution allows for faster reaction time of irrigation sequence while the single tank per solution allows for more variety of irrigation solution present at the same time.

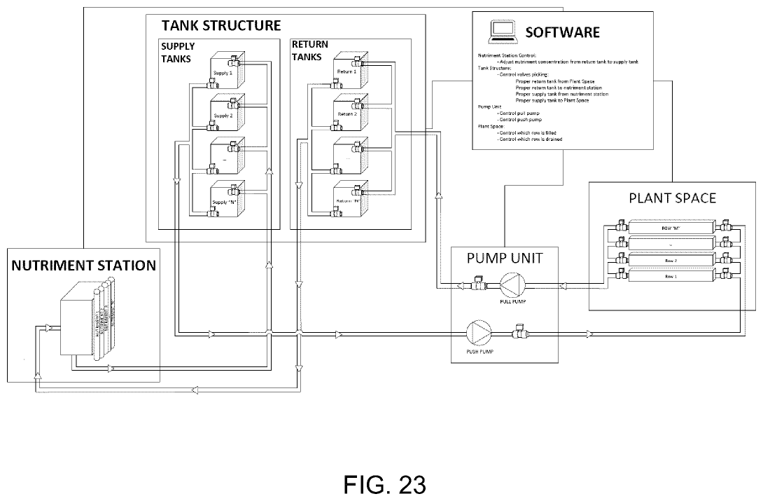

The system as illustrated schematically in FIG. 23 includes tanks within a tank structure, an irrigation hydraulic piping network, control software, plant spaces, and a concentrated solution tank (i.e. “mother” solution). For nutriment solution recycling, nutriment solution irrigation can be requested by the software with control options being shown below in Table 1.

TABLE 1
Control Options: Two Tanks per Nutriment Solution
and One Tank per Nutriment Solution

| Two Tanks per Nutriment Solution | One Tank per Nutriment Solution |
|---|---|
| The Nutriment Station fills the Supply Tank by | The Pump Module fills the Plant Space with |
| adjusting the Nutriment solution to the | the Nutriment Solution from the adequate |
| targeted concentration using the solution | Tank |
| available in the Return Tank (can be done | |
| pre-emptively) | |
| The Pump Module fills the Plant Space using | The Nutriment Station remove the Nutriment |
| the Nutriment solution from the adequate | Solution from the Plant Space and inject it in |
| Supply Tank. | the adequate Tank while adjusting the |
| The Pump removes the Nutriment Solution | Nutriment solution to the targeted |
| from the Plant Space to inject it in the | concentration. |
| adequate Return Tank | |

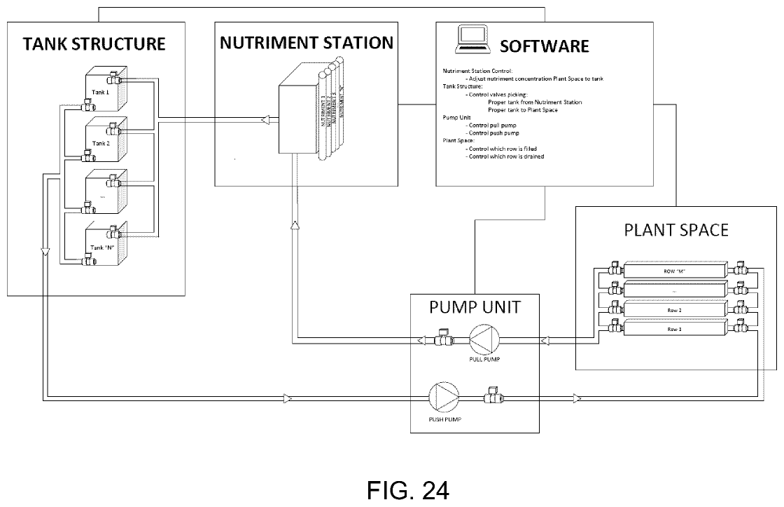

The control software system monitors and manages the nutriment solution storage. To adjust the nutriment solution, concentrated solution (from the mother solution) can be injected using the nutriment station. FIG. 23 illustrates a dual tank per nutriment station configuration and FIG. 24 illustrates a single tank per nutriment solution configuration.

It can be appreciated that the connectivity illustrated in FIGS. 23 and 24 can be extended to a global control system with multiple modules to control an overall growing environment. This can include a server with ethernet connections to different modules and a user interface to enable an operator to drive the system based on a customized schedule established by the grower. Lighting, irrigation, and nutriment cycles can be established and programed through such connectivity and data gathered through logs.

### Plant Carrying Tray

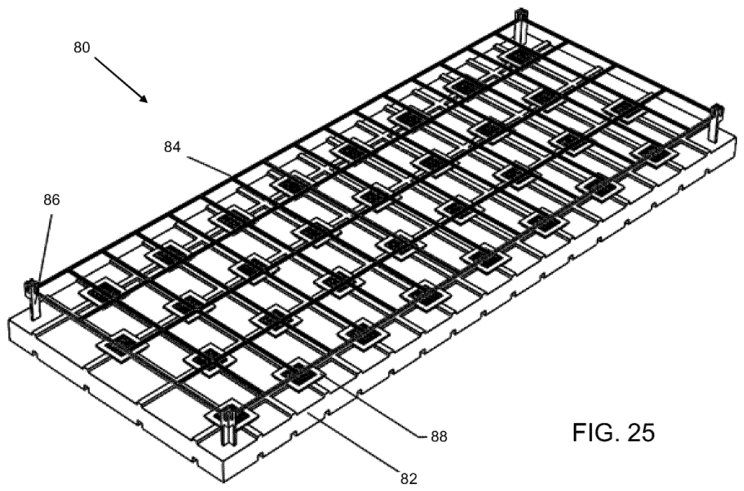

Referring to FIG. 25, a plant tray assembly 80 is shown again. The plant carrying tray 82 has multiple functions. It allows the conveying of the plant through a buoyancy control, it influences the plant substrate irrigation and drying, and it can be used as a foundation for the attachment of netting 84 to support heavy plants.

The plant submersion level is the level at which the irrigation liquid rises in relation to the plant containers in the tray 82. It is important to ensure that the maximum irrigation level and the minimum plant submersion level are adequate and that the plant submersion level occurs before the take off level. It will be influenced by the maturity of the plant because as weight changes throughout the plant life.

The take off level is the level of liquid necessary to allow the tray to float. At that level, adding more liquid will not affect the plant submersion level. The substrate drying factor refers to the ability of the substrate to dry. In the case of an absorbing plant container like wood fiber or coco fiber, it is affected by its exposure to the air.

Root area refers to the space where the roots exit the substrate container cage. It is the lower part of the plants that is submerged in liquid when irrigated. This space is not visible and does not receive any light.

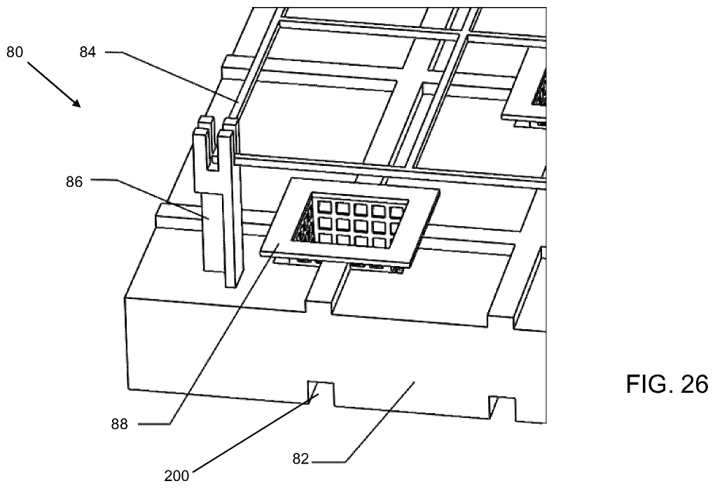

As discussed above and shown in greater detail in FIG. 26, the floating tray assembly 80 includes a floating tray 82, a number of substrate container cages 88 to be inserted into apertures in the floating tray 82, a heavy crop support netting 84, and supports 86 for the netting 84. Optionally, the cages 88 can hold plant containers but it is appreciated that it could just be a substrate in the cage 88. The assembly 80 would also include the substrate when fully assembled and ready for deployment in a row 14.

Buoyancy is achieved from the floating tray 82 and is controlled with the following parameters:

a) Type of Material: Polyethylene, Polypropylene, Polystyrene, crosslinked polyethylene, etc.

b) Density: e.g., 2 lb to 9 lb per cubic feet.

c) Thickness: 1 in to 3 in. for example.

d) Shape: liquid channels and other cut offs can be performed on the bottom of the tray.

e) Weight supported on the floating tray: substrate container cage 88, type and density of the substrate, plants, heavy crop support, liquid absorb from irrigation.

The first step is to define the plant need and establish the desired substrate. Substrates with a high liquid retention normally signify that it will be heavier and will require less irrigation. On the other hand, a low liquid retention substrate might indicate light weight and more irrigation. In respect to the substrate, the plant submersion level and the take off level are identified. One should also identify if the plant will require the heavy crop support netting 84 and define the number of plants on the floating tray 82 and the corresponding liquid channels or other cut offs needed.

From there one can establish a projected weight to be supported by the floating tray 82. The type of material, density and thickness should be chosen in accordance to the desired take off level. To facilitate the even distribution of the irrigation solution and prevent liquid trap, liquid channels 200 are created in the floating tray as seen in FIG. 26.

The buoyancy of the floating tray will dictate the take off level of the floating tray 82. The substrate container cage 88 can be made with an opening in such a way to allow a healthy root development. Root development is influenced by the wet/dry cycle of the irrigation from the system. An empty space is created between the substrate container cage 88, the floating tray 82 and the bottom of the plant space to limit the roots development.

A profile is available on the floating tray 82 to install a heavy crop support netting 84. It looks like a netting that can be made of plastics, elastics or fiber. The mounting support 86 can be made of plastics, composite or light metal.

For the substrate drying factor there are two possibilities:

1) Substrate container cage 88 is installed in such a way so that there is no air that can circulate inside of the root area. When irrigation subsides, it forces air inside of the substrate.

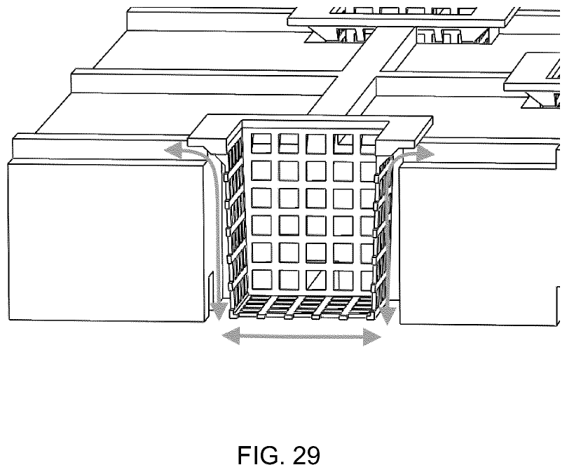

2) Substrate container cage 88 is installed in such a way so that air can circulate in and around the root area as shown in FIG. 29. A lip on the head of the substrate container cage 88 blocks the light from entering the root area. The substrate container cage 88 surface finish needs to be non reflective to prevent light entering the root space. This allows for an improved substrate drying factor and root respiration.

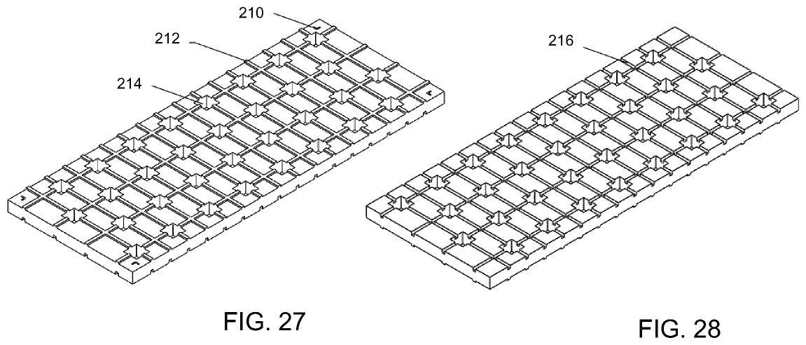

FIGS. 27 and 28 show the floating tray top view and bottom view. Features of note in these figures include a cavity for the net support 210, spacing ribs 212, a cavity 214 for the substrate container cage 88, and a cavity 216 for irrigation.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the software module(s), any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A multifunction beam for a growing system, the multifunction beam for installation along rows of the growing system, the beam comprising:
a profiled shape comprising a plurality of enclosed chambers and a plurality of slots or channels to interact with the growing system.

2. The beam of claim 1, comprising a gas chamber in communication with a plurality of orifices to permit gas to be distributed to a crop.

3. The beam of claim 2, further comprising a port for each orifice to receive a vented screw.

4. The beam of claim 3, further comprising an irrigation chamber and wherein the irrigation chamber is in communication with a drainage channel via a plurality of drainage ports.

5. The beam of claim 4, further comprising a drainage connector for collecting drained liquid via the irrigation chamber.

6. The beam of claim 5, comprising a lighting profile to support a lighting device.

7. The beam of claim 6, further comprising at least one assembly guide to be inserted in corresponding assembly slots in an adjacent beam.

8. A microclimate exchanger device, comprising:
a body comprising an air flow guide to guide air from an inlet through a cool coil assembly, through a hot coil assembly, and to an outlet;
at least one fan at the inlet of the body;
an air direction controller at the outlet of the body; and
an air filter positioned between the inlet and the outlet.

9. A microclimate exchange system, comprising:
at least one exchanger device according to claim 8;
a chiller;
a boiler;
a plurality of fans positioned within an area of a growing system to direct air through the at least one exchanger device; and
a plurality of enclosure panels to isolate the area.

10. The system of claim 9, further comprising a heat pump and wherein the area comprises a pair of adjacent rows in a level of a vertical farm configuration.

11. A growing system comprising:
a conveyor system;
at least one floating plant tray;
a plurality of multifunction beams for installation along rows of the growing system;
a microclimate exchange system; and
a nutriment supply system;
the conveyor system for a growing system, comprising;
a conveyor belt extending from one end of a row in the growing system to the other end of the row;
a first drive assembly coupled to the conveyor belt at the one end of the row;
a second drive assembly coupled to the conveyor belt at the other end of the row; and
a drive mechanism for operating the first and second drive assemblies and conveyor belt;
wherein the conveyor belt is attachable to the at least one floating plant tray to be conveyed along the row;
the at least one floating tray floating plant tray, comprising:
a buoyant body, the buoyant body comprising a plurality of insertion points for accepting a plant substrate;
a plurality of multifunction beams for installation along rows of the growing system, the beam comprising:
a profiled shape comprising a plurality of enclosed chambers and a plurality of slots or channels to interact with the growing system;
the microclimate exchange system, comprising:
a body comprising an air flow guide to guide air from an inlet through a cool coil assembly, through a hot coil assembly, and to an outlet;
at least one fan at the inlet of the body;
an air direction controller at the outlet of the body; and
an air filter positioned between the inlet and the outlet; and
the nutriment supply system, comprising:
a tank structure comprising at least one tank;
a nutriment station coupled to the at least one tank;
a pump unit coupled to the at least one tank and coupled to a growing system in a plant space; and
a software module configured to control distribution of the nutriment from the nutriment station to the plant space via the tank structure.

12. The system of claim 11, wherein the belt is attachable to a cleaning system.

13. The system of claim 12, further comprising a driving assembly and a drive belt extending between the driving assembly and the first drive assembly to permit the driving assembly to operate the first drive assembly from a lateral position.

14. The system of claim 13, further comprising at least one access ramp for deploying the objects into the row to attach to the conveyor belt.

15. The system of claim 11 wherein the floating plant tray further comprises a plurality of substrate container cages insertable into the insertion points of the tray.

16. The system of claim 15, wherein the cages are configured to provide a gap between a flange thereof and the tray body to permit air flow around the plant substrate.

17. The system of claim 16 wherein the tray further comprising a plurality of supports and a heavy crop support.

19. The system of claim 11, wherein the tank structure of the nutriment distribution system further comprises at least one supply tank and at least one return tank.

20. The system of claim 19, wherein the tank structure of the nutriment distribution system further comprises a plurality of supply tanks and a plurality of return tanks.
